(19) United States
(12) Patent Application Publication
(10) Pub. No.: US 2025/0209761 A1
(43) Pub. Date: Jun. 26, 2025

(54) CONVERSATIONAL DIGITAL CHARACTER BLENDING AND GENERATION

(71) Applicant: SOUL MACHINES LIMITED, Auckland (NZ)

(72) Inventors: Tim Wu, Auckland (NZ); Charlene Mauger, Auckland (NZ); Christian Blume, Auckland (NZ); Felix Marcon Swadel, Auckland (NZ); Jung Shin, Auckland (NZ); Sibylle Van Hove, Auckland (NZ)

(21) Appl. No.: 18/852,223

(22) PCT Filed: Mar. 31, 2023
(86) PCT No.: PCT/IB2023/053228

§ 371 Date: Sep. 27, 2024

(30) Foreign Application Priority Data
Mar. 31, 2022 (NZ) 786836

(51) Int. Cl. G06T 19/20; G06T 13/20; G06T 13/40

(52) U.S. Cl. CPC G06T 19/20; G06T 13/205; G06T 13/40; G06T 2219/2012; G06T 2219/2016; G06T 2219/2021; G06T 2219/2024

(57) ABSTRACT

Embodiments of the invention provide efficient and intuitive techniques for creating digital characters. One embodiment of the invention provides a method of customizing a digital avatar. A digital avatar may be displayed on a display of an electronic device. An audio-visual user interface may be provided for customizing the digital avatar based on a spoken conversation between a user and the digital avatar.

### TECHNICAL FIELD

The present invention generally concerns the field of computer graphics, and in particular techniques for customizing digital avatars in a realistic yet user-friendly manner.

### BACKGROUND

The human face is a key component of human interaction and communication. For this reason, the generation of realistic face models has been one of the most interesting problems in computer graphics.

Digital character creating tools typically come with various interface designs offering a range of levels of user involvement. Some approaches try make the user experience as simple as possible and thus offer few or no customization options. For example, WO 2019/050808 A1 of Pinscreen, Inc. titled “Avatar digitization from a single image for real-time rendering” discloses a system for generating three-dimensional facial models including photorealistic hair and facial textures by creating a facial model with reliance upon neural networks based upon a single two-dimensional input image. As another example, Scalismo is a library for statistical shape modeling and model-based image analysis in Scala, developed by the Graphics and Vision Research Group at the University of Basel. The project aims to provide an environment for modelling and image analysis which makes it easy and fun to try out ideas and build research prototypes and, at the same time, is powerful enough to build full-scale industrial applications. By focusing on the creation of random faces sampled from statistical models, Scalismo provides little customization control.

Other approaches are based on graphical user interfaces which allow the user to customize a digital avatar by way of certain preselected swappable features (e.g., for facial hair, face shape, wrinkles), sliders (e.g., for weight, age, ethnicity) and/or deformable features modified via a sparse set of locators (e.g., to morph the nose, mouth, eyes, jaw). Examples include Unreal Metahuman Creator, MakeHuman, Nintendo Miis and Character Creator by Reallusion Inc.

WO 2020/085922 A1 of the applicant titled “Digital character blending and generation system and method”, the contents of which are incorporated by reference herein, discloses a method for creating a model of a virtual object or digital entity. The method comprises receiving a plurality of basic shapes for a plurality of models, receiving a plurality of specified modification variables specifying a modification to be made to the basic shapes, and applying the specified modification(s) to the plurality of basic shapes to generate a plurality of modified basic shapes for at least one model. This allows users to customize a digital human using a graphical user interface with control elements, such as sliders, radio buttons, and the like.

However, providing a control interface with graphical control elements has severe limitations in certain scenarios. For example, when there are multiple, possibly hundreds of thousands, of control parameters that contribute to the look of the digital human, the known graphical user interfaces and their control elements can become overwhelming or even simply inadequate to account for the complexity of the task at hand.

It is therefore a problem underlying the invention to provide more efficient and/or intuitive techniques for creating digital characters which overcome the above-mentioned disadvantages of the prior art at least in part.

### SUMMARY

One embodiment of the invention provides a method of customizing a digital avatar. A digital avatar may also be referred to herein as “avatar”, “digital character”, “digital human”, “virtual agent”, or the like. Such a digital avatar may provide a digital representation of a real or fictious human. The concepts and principles disclosed herein are, however, not limited to digital humans. Accordingly, a digital avatar may likewise represent any kind of virtual organism, e.g., in the form of a humanoid, animal, alien, creature, or any life-like animated entity of a certain visual appearance. In the broadest sense, a digital avatar may comprise any type of embodied agent, e.g. in the form of a virtual object or digital entity. Accordingly, digital avatars may include both large models of humans or animals, such as a human face, as well as any other model represented, or capable of being used, in a virtual or computer-created or computer-implemented environment. In some cases, the digital avatar may not be complete, but may be limited to a portion of an entity, for instance a body portion such as a hand or face; in particular where a full model is not required. A digital avatar is preferably animated and thus capable of displaying multiple facial expressions.

In one aspect of the invention, a digital avatar may be displayed on a display of an electronic device. An audio-visual user interface may be provided for customizing the digital avatar based on a spoken conversation between a user and the digital avatar. Accordingly, this aspect of the invention departs from the known approach to provide, and possibly overwhelm, the user with several user interface control elements in the form of buttons, sliders and the like, to customize a digital avatar. Instead, the described aspect of the invention provides an audio-visual interface which allows the user and the avatar to conduct a spoken conversation during the customization process. This way, the user can be guided through the customization process by way of the avatar conversing with the user. This enables the user to create the desired look in a faster and more intuitive manner, allowing the user to focus on creativity without being overwhelmed by a complex graphical user interface. In other words, this aspect of the invention assists the user in performing the technical task of generating a realistic digital avatar by means of a continued and guided human-machine interaction process.

In one aspect of the invention, the method may receive, from the user via a microphone of the electronic device, speech input indicating a customization request. The method may further comprise providing, by the digital avatar via a speaker of the electronic device, speech output indicating a customization response and simultaneously animating the digital avatar on the display of the electronic device consistently with the speech output. Using the microphone, speaker and display of the electronic device creates a coherent and particularly convenient user experience.

In another aspect of the invention, the customization request comprises a query for customization options, and the customization response comprises at least one customization option. The at least one customization option may depend on a state of a current customization session. Accordingly, feedback and/or suggestions can be provided in real-time to guide the user through the customization process in a particularly intuitive and user-friendly manner.

In another aspect of the invention, the method comprises the step of determining whether the customization request meets one or more customization constraints, and the step of customizing the digital avatar in accordance with the customization request if, preferably only if, the one or more customization constraints are met. Accordingly, this aspect ensures that the digital avatar can be customized only within certain predefined reasonable boundaries, which reduces the likelihood of creating uncanny looking faces by letting the user know during the conversation. In particular, the method may ensure that the user can only create a natural and/or demographically consistent face.

In another aspect of the invention, the digital avatar comprises a face with a plurality of customizable facial regions. Each facial region may have one or more customizable facial parameters. The facial regions may include one or more of: nose, with one or more of the following facial parameters: base width, middle width, nostril width, nostril tilt, length, protrusion, dorsal curvature; mouth, with one or more of the following facial parameters: lip thickness, width, upper lip-to-lower lip ratio, protrusion; eyes, with one or more of the following facial parameters: width, height, protrusion. The face may have one or more customizable appearance parameters, including one or more of skin tone, eyebrow facial hair, beard facial hair, amount of freckles, eye color, hairstyle. Accordingly, this aspect allows a particularly fine-grained customization of the digital avatar. The plurality of facial regions, facial parameters and/or appearance parameters may be independently customizable, preferably each region/parameter independent of the other regions/parameters.

In another aspect of the invention, the method comprises generating an initial configuration of the digital avatar. The initial configuration may comprise a randomly generated face. The face may be constructed based on a predefined set of phenotypes. The predefined set of phenotypes may comprise representations of faces digitized from real humans. The initial configuration may be constructed from a random blend of a subset of the predefined set of phenotypes. Preferably, the subset comprises demographically consistent phenotypes. Accordingly, the customization process may start with a randomly generated face that, despite its randomness, is constructed from demographically consistent phenotypes. Demographically consistent means that phenotypes share similar demographics, such as age and/or gender, and/or have similar anatomical structures and/or skin tones. The predefined set of phenotypes may be decomposed into a plurality of elementary facial features which are usable to reconstitute a new face. Using demographically consistent phenotypes ensures that the resulting facial features of the customized digital avatar are consistent and more natural across different facial regions.

Accordingly, the customizability of the blends may be limited by the size and/or variations defined by the predefined set of phenotypes. To minimize the effects of this limitation, the dataset may be augmented to allow independent control of facial feature modification, as already mentioned.

In another aspect of the invention, the one or more customization constraints are based on a face model which has been trained to learn a variability of facial parameters using a machine-learning technique.

Using a pre-trained model that maps from facial measurement to blending parameters can be particularly efficiently stored in memory. The real-time algorithm can be very light-weight and can be implemented, e.g., on the user's electronic device, or on a server and streamed to the user device depending on the user's need.

Accordingly, certain embodiments may be based on using a machine-learning model and/or machine-learning algorithm. Machine learning may refer to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and/or training sequences (e.g. words or sentences) and associated training content information (e.g. labels or annotations), the machine-learning model “learns” to recognize the content of the images, so the content of images that are not included in the training data can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model. The provided data (e.g., sensor data, metadata and/or image data) may be preprocessed to obtain a feature vector, which is used as input to the machine-learning model.

Machine-learning models may be trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm (e.g., a classification algorithm, a regression algorithm or a similarity learning algorithm. Classification algorithms may be used when the outputs are restricted to a limited set of values (categorical variables), i.e., the input is classified to one of the limited set of values. Regression algorithms may be used when the outputs may have any numerical value (within a range). Similarity learning algorithms may be similar to both classification and regression algorithms but are based on learning from examples using a similarity function that measures how similar or related two objects are. Apart from supervised or semi-supervised learning, unsupervised learning may be used to train the machine-learning model. In unsupervised learning, (only) input data might be supplied and an unsupervised learning algorithm may be used to find structure in the input data (e.g. by grouping or clustering the input data, finding commonalities in the data). Clustering is the assignment of input data comprising a plurality of input values into subsets (clusters) so that input values within the same cluster are similar according to one or more (pre-defined) similarity criteria, while being dissimilar to input values that are included in other clusters.

Reinforcement learning is a third group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Furthermore, some techniques may be applied to some of the machine-learning algorithms. For example, feature learning may be used. In other words, the machine-learning model may at least partially be trained using feature learning, and/or the machine-learning algorithm may comprise a feature learning component. Feature learning algorithms, which may be called representation learning algorithms, may preserve the information in their input but also transform it in a way that makes it useful, often as a pre-processing step before performing classification or predictions. Feature learning may be based on principal components analysis or cluster analysis, for example.

In some examples, anomaly detection (i.e., outlier detection) may be used, which is aimed at providing an identification of input values that raise suspicions by differing significantly from the majority of input or training data. In other words, the machine-learning model may at least partially be trained using anomaly detection, and/or the machine-learning algorithm may comprise an anomaly detection component.

In some examples, the machine-learning algorithm may use a decision tree as a predictive model. In other words, the machine-learning model may be based on a decision tree. In a decision tree, observations about an item (e.g., a set of input values) may be represented by the branches of the decision tree, and an output value corresponding to the item may be represented by the leaves of the decision tree. Decision trees may support both discrete values and continuous values as output values. If discrete values are used, the decision tree may be denoted a classification tree, if continuous values are used, the decision tree may be denoted a regression tree.

Association rules are a further technique that may be used in machine-learning algorithms. In other words, the machine-learning model may be based on one or more association rules. Association rules are created by identifying relationships between variables in large amounts of data. The machine-learning algorithm may identify and/or utilize one or more relational rules that represent the knowledge that is derived from the data. The rules may, e.g., be used to store, manipulate or apply the knowledge.

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge (e.g. based on the training performed by the machine-learning algorithm). In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a retina or a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of its inputs (e.g., of the sum of its inputs). The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input.

Alternatively, the machine-learning model may be a support vector machine, a random forest model or a gradient boosting model. Support vector machines (i.e. support vector networks) are supervised learning models with associated learning algorithms that may be used to analyze data (e.g., in classification or regression analysis). Support vector machines may be trained by providing an input with a plurality of training input values that belong to one of two categories. The support vector machine may be trained to assign a new input value to one of the two categories. Alternatively, the machine-learning model may be a Bayesian network, which is a probabilistic directed acyclic graphical model. A Bayesian network may represent a set of random variables and their conditional dependencies using a directed acyclic graph. Alternatively, the machine-learning model may be based on a genetic algorithm, which is a search algorithm and heuristic technique that mimics the process of natural selection.

In another aspect of the invention, a method of generating a face model is provided for use in a method of customizing a digital avatar, in particular in accordance with any of the methods described above. The method may comprise providing an initial set of phenotypes comprising representations of faces, preferably digitized from real humans. The method may comprise, for each of a selected one of a plurality of facial regions, generating blended facial regions based on a blending of multiple phenotypes, in particular using linear combination.

In another aspect, the method further comprises generating a low-dimensional representation of the variation in the blended phenotypes, in particular using principal component analysis.

In another aspect, the method further comprises learning a variability of facial parameters in the initial set of phenotypes using a machine-learning technique.

Some or all of the aspects of the methods disclosed herein may be computer-implemented.

In another aspect of the invention, a data processing apparatus or system is provided, comprising means for carrying out any of the methods disclosed herein. Also, a computer program and a computer-readable medium having stored thereon the computer program are provided, the computer program comprising instructions which, when executed by a computer, cause the computer to carry out any of the methods disclosed herein.

Certain aspects of the invention, such as the generation and animation of the digital avatar, may be realized using or building on techniques disclosed in WO 2020/085922 A1 “DIGITAL CHARACTER BLENDING AND GENERATION SYSTEM AND METHOD” of the applicant, which discloses systems and methods for digital character blending and generation, and/or techniques disclosed in WO 2015/016723 A1 “SYSTEM FOR NEUROBEHAVIORAL ANIMATION” of the applicant, which discloses systems and methods for animating a virtual object or digital entity with particular relevance to animation using biologically based models, or (neuro) behavioral models. The contents of said documents are incorporated herein by reference.

Certain aspects of the invention, such as the conversational flow of the customization conversation, may be realized using or building on techniques disclosed in WO 2021/005551 A1 “CONVERSATIONAL MARK-UP IN EMBODIED AGENTS” of the applicant, which discloses systems and methods for on-the-fly animation of embodied agents and automatic application of markup and/or elegant variations to representations of utterances to dynamically animate embodied agents. The contents of said document are incorporated herein by reference.

Certain aspects of the invention, such as the graphical animation of the digital avatar speaking, may be realized using or building on techniques disclosed in WO 2020/152657 A1 “REAL-TIME GENERATION OF SPEECH ANIMATION” of the applicant, which discloses systems and methods for real-time generation of speech animation. The contents of said document are incorporated herein by reference.

### BRIEF DESCRIPTION OF THE DRAWINGS

The disclosure may be better understood by reference to the following drawings:

FIG. 1: A user interface for conversational customization of a digital avatar in accordance with embodiments of the invention.

FIG. 2: A process for generating a face model in accordance with embodiments of the invention.

FIG. 3: A process for real-time customization of a digital avatar in accordance with embodiments of the invention.

FIG. 4: A graphical representation of three facial regions of interest (nose, eyes and mouth) in accordance with embodiments of the invention.

FIG. 5A: Facial parameters relating to the nose in accordance with embodiments of the invention.

FIG. 5B: Facial parameters relating to the mouth in accordance with embodiments of the invention.

FIG. 5C: Facial parameters relating to the eyes in accordance with embodiments of the invention.

FIG. 5D: Curvature measurements relating to the nose in accordance with embodiments of the invention.

FIG. 6: An exemplary phenotype database with 4 phenotypes in accordance with embodiments of the invention.

FIG. 7: An exemplary customization conversation in accordance with embodiments of the invention.

### DESCRIPTION OF PREFERRED EMBODIMENTS

Embodiments of the invention, which may also be referred to herein as voice-controlled digital human blender, provide an efficient human-machine interface for customizing a digital avatar from conversation.

### User Interface

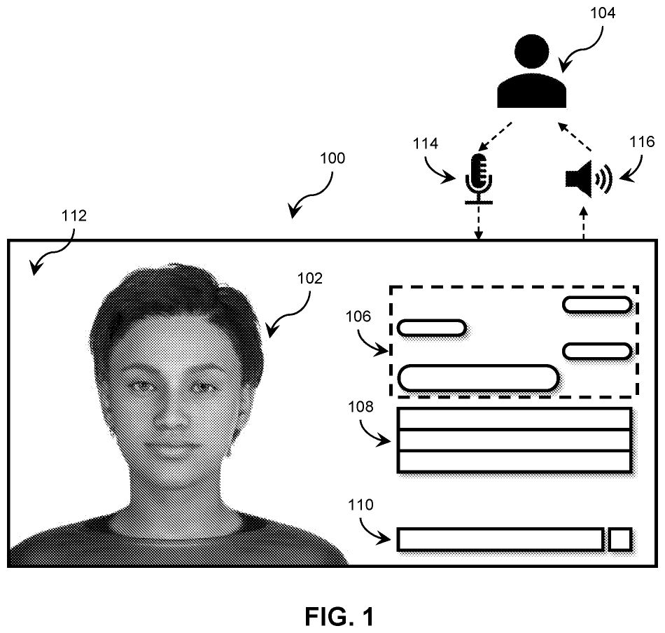

FIG. 1 shows a user interface 100 according to one embodiment. The user interface 100 comprises a display 112 which displays a digital avatar 102. The user interface 100 also comprises a microphone 114 and a speaker 116, thereby providing an audio-visual interface allowing a user 104 to interact with the digital avatar 102 in a customization conversation, which will be explained in more detail further below. In the illustrated embodiment, the display 112, the microphone 114 and the speaker 116 are arranged in an electronic device (not shown in FIG. 1).

In the embodiment shown in FIG. 1, the user interface 100 comprises further user interface components besides the audio-visual interface, namely a graphical display 106 of the text of the customization conversation, user-selectable customization options 108 and a text input field 110. These additional user interface components may further improve the human-machine interaction but may be omitted in certain embodiments.

### Conversation Design

Certain embodiments use natural language processing (NLP) techniques to understand the intent of the user and to drive the blending parameters through these intents. A combination of NLP and/or regular expression matching may be used to extract the user's feature modification intent. The method may also display a selection of possible modifications to drive the discussion, as illustrated by the customization options 108 in FIG. 1. The method advises the user when a requested feature modification is outside a defined range. The avatar's questions and responses to the user may be generated using NLP or other similar techniques.

In certain embodiments, the customization functionality is built on top of an existing animation engine. One example is the Digital DNA (DDNA) blender product developed by the applicant, which allows users to create their own custom digital avatar using slider controls as disclosed in WO 2020/085922 A1. This allows the avatar to be autonomously animated during the design process, i.e. in real-time, which provides real-time feedback to the user on how the facial features of the created avatar will look when articulating.

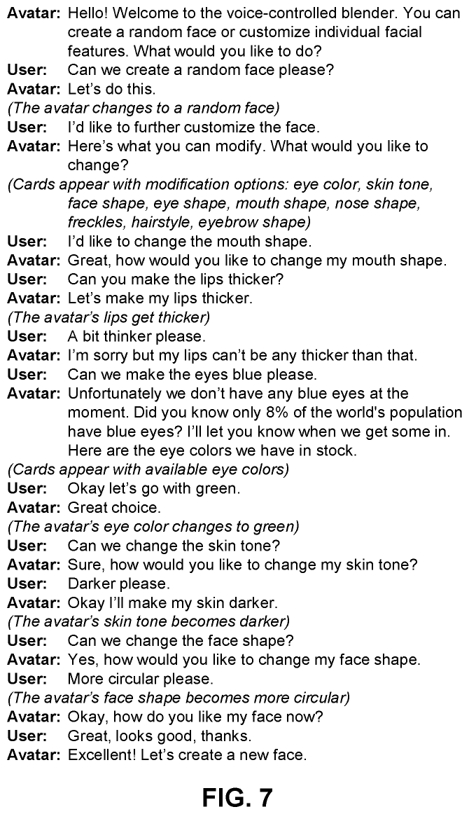

Therefore, the conversation can be designed to go through various visemes and facial expression sequences. An exemplary conversation listing is provided in FIG. 7.

A practical implementation in accordance with embodiments of the invention uses the English multi-task CNN model from spaCy (en_core_web_sm module). spaCy is an open-source library for Natural Language Processing in Python which features NER, POS tagging, dependency parsing and word vectors.

In one embodiment, the model was trained on OntoNotes and optimized for CPU. The OntoNotes project is a collaborative effort between BBN Technologies, the University of Colorado, the University of Pennsylvania and the University of Southern California's Information Sciences Institute. The goal of the project was to annotate a large corpus comprising various genres of text (news, conversational telephone speech, weblogs, usenet newsgroups, broadcast, talk shows) in three languages (English, Chinese, and Arabic) with structural information (syntax and predicate argument structure) and shallow semantics (word sense linked to an ontology and coreference).

When the user makes a customization request, the NLP model identifies the nouns and the corresponding adjectives/adverb-adjectives. For example, if the user says:
“can you make my eyes rounder, my skin darker and my eyebrows more defined”, the NLP will pass the following command to the script:
eyes/rounder, skin/darker, eyebrows/more defined

The script will then execute those orders and generate an avatar with the corresponding customizations.

### Offline Processing

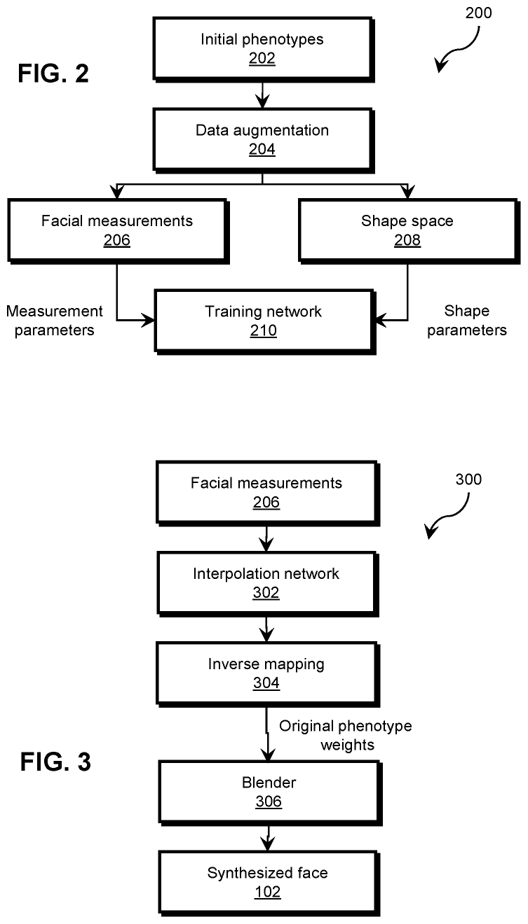

In the following, a process 200 for generating a face model in accordance with an embodiment of the invention will be described with reference to FIG. 2.

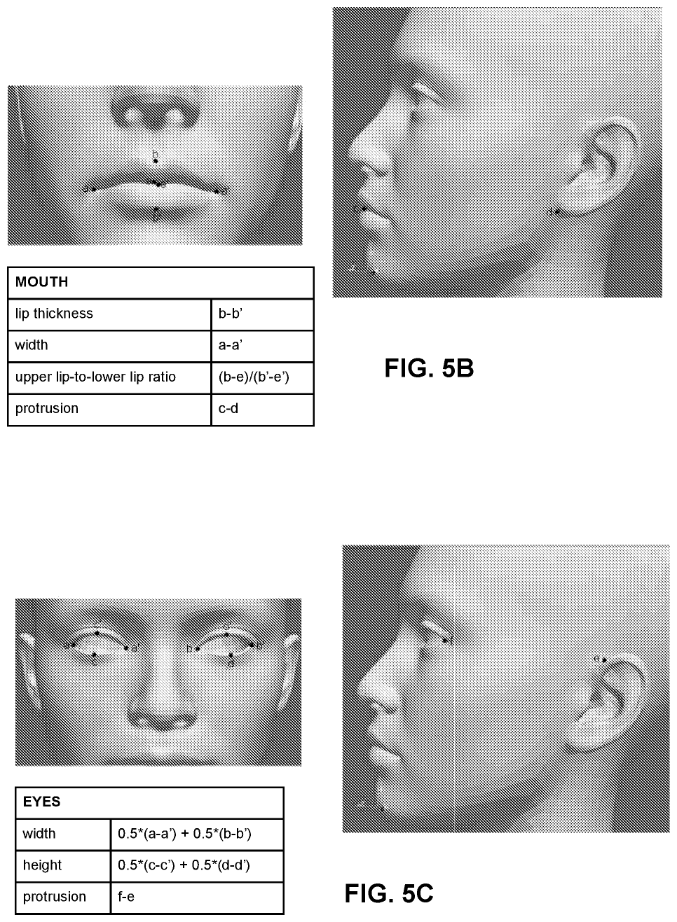

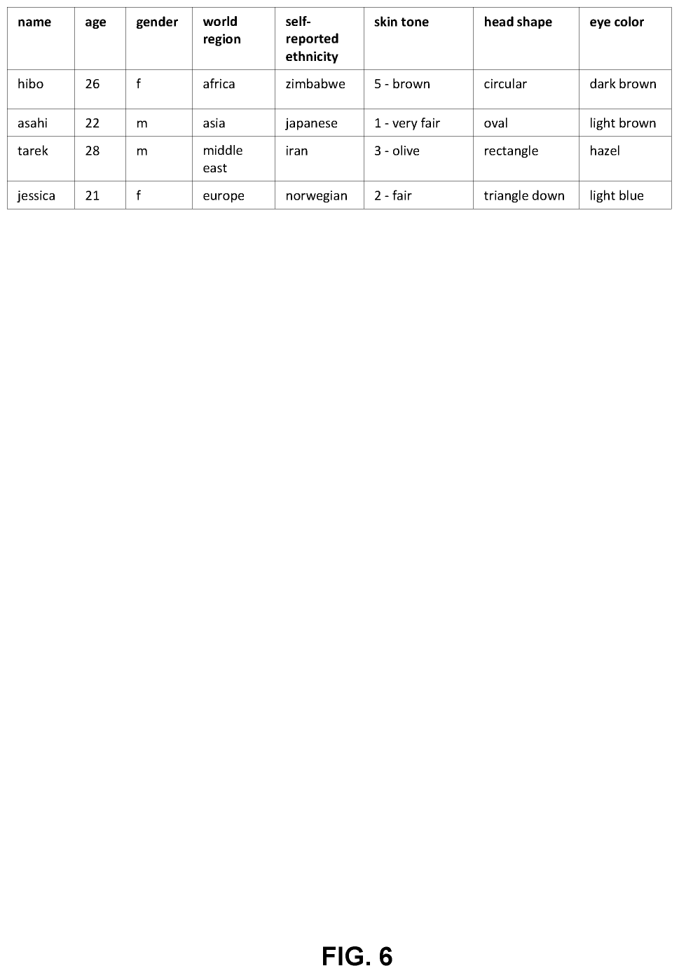

The process takes as input an initial phenotype dataset, i.e., a set of initial phenotypes 202, also referred to herein as phenotype database. The phenotypes may be defined by factors such as age, gender, world region, (self-reported) ethnicity, skin tone, head shape and/or eye color. A practical example of a phenotype dataset with 4 phenotypes is shown in FIG. 6. Based on the phenotype dataset, a data augmentation process 204 generates an augmented dataset for each of a plurality of facial regions, also referred to as regions of interest (ROI). In the illustrated example, the ROIs are the nose, the eyes and the mouth, as shown in FIG. 4, which facial regions of interest are anatomically inspired. In other embodiments, different or additional regions may be used, such as the forehead, the cheekbone, the chin, the ears, etc., if needed. In one practical embodiment, the data augmentation is performed using linear combinations of the existing phenotypes on the facial ROIs. Linear combination is fast to implement and works well for the task at hand, but other augmentation methods may be used for augmenting the dataset.

In a preferred embodiment, all possible combinations of three or four phenotypes are selected. The inventors have found that a combination of two to four phenotypes results in uniquely looking faces and at the same time provides enough variations. Blending two or less phenotypes likely creates faces that look too similar to the original phenotypes. Blending more than four phenotypes often results in faces that are too average and symmetrical and therefore lose an individual's uniqueness and character.

The selected phenotypes are blended together using random weights. Regional blending may be used, e.g., as disclosed in WO 2020/085922 A1. The weights W used to generate each new phenotype are saved, e.g., in matrix form, to be used to recover the initial phenotypes. Each region of interest (in the example: nose, eyes and mouth) is augmented independently. In the illustrated example, the resulting number of generated phenotypes is 968 phenotypes.

In certain embodiments, texture components, such as freckles, skin tone, eyebrows, eye color, color of the lip, may also be augmented using the same or a similar blending system.

In certain embodiments, dimensionality reduction, e.g., using principal component analysis (PCA), may be used to provide a low-dimensional representation of shape and/or texture variation. The process may build one PCA model per ROI (in the example: nose, eyes and mouth) using local masks and per texture features (skin tone, facial hair, freckles and blemishes etc.). This allows each ROI to be processed independently and to form its own shape space 208, so that each part can be varied independently.

In one particular embodiment, the choice is to keep enough components to explain 99% of the total variations. After the PCA, each phenotype ROI Si can be approximated by:

$${S}_{i} ≃ \underline{X} + {Σ}_{j = 1}^{M} {U}_{j} {T}_{j}^{T} \qquad ( 1 )$$

where X is the average shape of the ROI, M is the number of components kept, T are the eigenvectors (the new coordinate system) and U are the principal component scores (new coordinates in the new reference). This provides a low-dimensional representation of the variation, parameterized by U={U₁, U₂, U₃, . . . , U_{M}}. In other embodiments, this latent vector may also be extracted using other techniques, such as autoencoder, partial least squares, factor analysis, linear discriminant analysis, or the like.

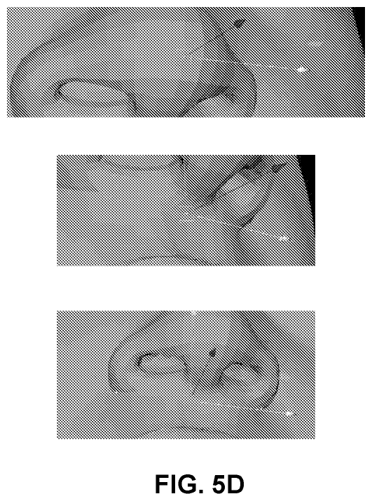

Although PCA modes represent the direction with the most important direction of variation, they may not fully correspond to the face shape and appearance description used in human language. In one embodiment, 14 facial measurements and five appearance parameters are selected, based on their intuitiveness, correlations and ability of generating a huge variety of accurate facial conformation using the methodology disclosed in L. G. Farkas. “Anthropometry of the Head and Face”, Raven Press, 1994. and Li, Zhida, Ji Ma, and Hsi-Yung Feng. “Facial conformation modeling via interactive adjustment of hierarchical linear anthropometry-based parameters.” Computer-Aided Design and Applications 14.5 (2017): 661-670. These articles characterize the human face using linear distances and angle measurements between predefined anthropomorphic landmark points. For interactive deformation, the number of parameters should be small enough for ease of use, while capable of generating accurate facial conformation. In embodiments of the invention, five side face parameters and nine front face parameters can be customized as listed in FIGS. 5A-C.

As for the appearance, one embodiment of the invention provides five customizable parameters, namely:
Skin tone (from very fair (pale) to brown)
Facial hair: eyebrows (from defined to bushy) and beard/stubble
Amount of freckles: from none to dense
Eye colors: blue, green, hazel, brown, dark
Hairstyle

Other measurements which may be used in addition or alternatively include the following measurements of curvature, e.g., in addition to the angle subtended between three mesh-points:
Angle deficit: 180−sum (angles subtended at a particular mesh-point)
Gaussian curvature and mean curvature as defined by Meyer at al. (https://people.eecs.berkeley.edu/˜jrs/meshpapers/MeyerDesbrunSchroderBarr.pdf, https://computergraphics.stackexchange.com/a/1721)
Principal curvatures calculated from Gaussian and mean curvatures from Meyer et al.

Specifically, these curvature measurements were used at the tip of the nose, the base of the nose/top of the philtrum, and at the leftmost and rightmost points of the nose lobes, as illustrated in FIG. 5D.

Also partially specified measurements are conceivable, in particular when the user wants to specify some, but not all measurements for a region of the face. The remaining measurements need to be selected automatically. Embodiments of the invention propose to use the covariance of the specified and non-specified measurements in the set of example faces to estimate a range of acceptable values for each non-specified measurement, and then use a normal distribution to select a value from within that range.

The process calculates the line of best fit between measurement pairs (mᵢ, mⱼ) for each example face and the standard deviation of points away from the line. For a user-specified mⱼ the process then calculates mᵢ(mⱼ) from the line of best fit, and uses for the measurement:

mᵢ′=normal(mᵢ(mⱼ),σ(mᵢ,mⱼ)

This ensures that the measurements generated automatically will be reasonably within the space of valid face shapes defined by the example faces.

In the described embodiment, each measurement was normalized such that the mean of all of the values was 0 and the standard deviation was 1 (z-score).

Certain embodiments may use linkage between PCA modes and facial measurements. This may be done by way of Radial basis function (RBF) interpolation (illustrated as training network 210 in FIG. 2), which, given an arbitrary input measurement in the measurement space (normalized measurements), constructs a smooth interpolating function expressing the deformation in terms of the changes in U (PCA scores). This generates as many RBF-based interpolation functions as the number of eigenvectors. RBF with a thin-plate spline kernel may be used in this embodiment. Having the shape and texture interpolators formulated, the runtime shape and texture customization is reduced to the interpolation function evaluation according to the face/texture attribute parameters.

As the thin-plate kernel RBF interpolation minimizes the bending energy of a function (as it depends on its second derivatives), it gives a very smooth interpolation and was therefore chosen for this application. Thin-plate kernel RBF interpolants have also been shown to be very accurate in surface reconstruction (see Carr, Jonathan C., et al. “Reconstruction and representation of 3D objects with radial basis functions.” Proceedings of the 28th annual conference on Computer graphics and interactive techniques. 2001.).

Let U′ be the interpolated PCA scores after RBF interpolation at a given measurement input. The interpolated shape is reconstructed as follows:

$$S = \underline{X} + {U}^{′} {T}^{T} \qquad ( 2 )$$

The relationship between PCA modes and facial measurements may also be trained using other techniques, such as statistical regressors, support vector machines (SVM) or any other predictive regression models.

### Runtime Application

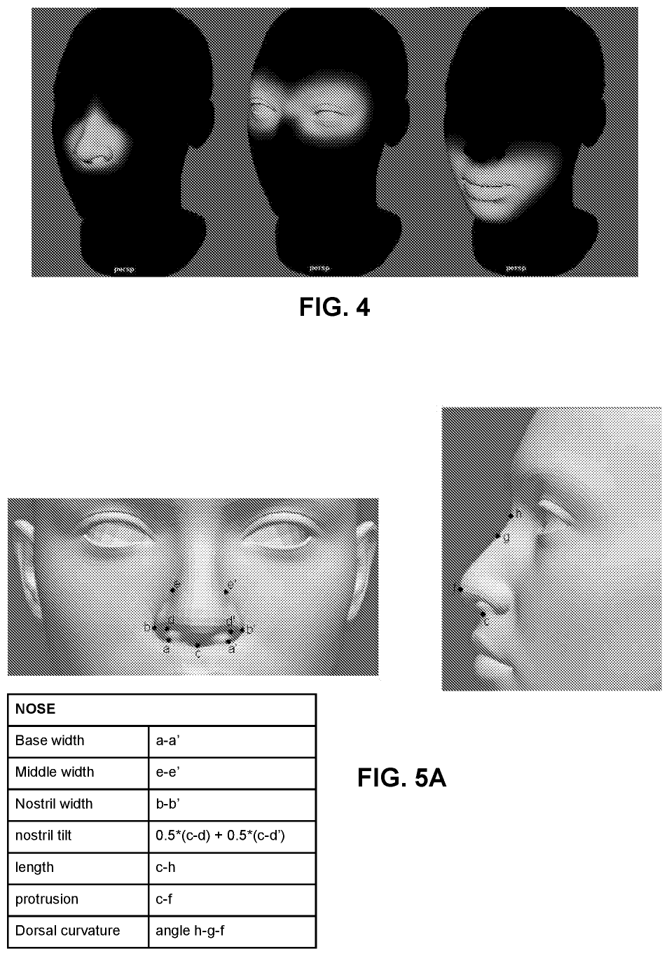

In the following, a process for real-time customization of a digital avatar 102 in accordance with an embodiment of the invention will be described with reference to FIG. 3.

The process may start with a demographically consistent random blend of the existing phenotypes available in the phenotype database. The generated initial avatar 102 is displayed to the user, preferably in an animated manner.

Internally, the process creates a lookup table/measurement vectors storing the current facial measurements 206 of the generated phenotype as a set of z-scores.

Next, the digital avatar 102 presents what parts of the face can be modified and asks the user what needs to be changed.

Natural language processing techniques are used to generate contextual information of the speech, e.g., the face part needed to be changed and how (for further details see section “Conversation design”).

The process then looks up the table for the current input measurement vector and increases it by one standard deviation. The predefined interpolation functions 302 are evaluated to generate the appropriate shape by taking the measurement vector as input and the corresponding PCA scores are computed. This gives U′ in equation (2).

The look-up table is updated and the interpolated shape is reconstructed using equation (2).

Certain embodiments may include inverse mapping 304 to recover the weight needed to be applied to each of the phenotypes present in the phenotype database. This allows the generated avatar 102 to be autonomously animated. Let X be a data matrix with n rows (number of phenotypes; in the example: 15) and m columns (shape vertices and color). If linear combinations of the 15 existing phenotypes were used to generate the augmented dataset, the aim is to find the weights Ψ={α₁, α₂, . . . , α₁₅} such that:

$$S = {X}^{T} Ψ = \underline{X} + {U}^{′} {T}^{T}$$

where X is the mean shape from the PCA, T are the PCA eigenvectors and U′ are the interpolated PCA scores at the input measurements after RBF interpolation. To enforce the weights to be positive, a non-negative least squares optimization problem may be defined:

$$solveA Ψ = b$$

$$subject Ψ = \{ {α}_{1} , {α}_{2} , … , {α}_{n} \} ∈ {R}^{+}$$

$$With b = \underline{X} + {U}^{′} {T}^{T} and A = {X}^{T}$$

Comparison with Known Techniques

Several face modeling methodologies are currently available and can be classified into two categories: reconstructive and creative approaches. Creative approaches provide easy manual specification and interactive control by the users and were initially introduced in N. Magnenat-Thalmann, H. Minh, M. deAngelis, and D. Thalmann. “Design, transformation and animation of human faces.” The Visual Computer, 5:32-39, 1989. and M. Patel and P. Willis. “FACES: the facial animation, construction and editing system.” Eurographics'91, pp. 33-45, 1991. While providing an easy and full control over the generated faces, their ability to produce caricatural effects and unrealistic results make them less suitable for many application scenarios.

With embodiments of the invention, a 3D morphable face model (3DMM) is provided which follows a reconstructive approach. Certain embodiments use face geometry information from real subjects. By estimating control models on the extracted statistics from real example models, the output of the system inherently maintains the quality and realism that exists in the real faces of individuals and avoids the dreaded uncanny valley. In certain embodiments, the face reconstruction is constrained to lie within the linear span of phenotypes used to build the PCA model explained further above. What makes this approach powerful is the dramatic reduction in the degree of freedom of the face reconstruction problem, while enabling extremely impressive results.

### GENERAL REMARKS

Certain embodiments have been described which provide an intuitive way to customize a digital avatar by letting the user describe the features of the avatar, in particular the avatar's face, and the desired customization options. Certain embodiments provide a framework which guides the creative process in an interactive manner, which makes the avatar creation accessible to non-professional communities.

On the one hand, providing a conversation backend may increase network traffic and may requires speech-to-text (STT) and/or natural language understanding (NLU) services to interpret the user's intent, as well as natural language generation (NLG) and text-to-speech services to deliver the avatar's response. The inventors have found that the increase in traffic, however, does not outweigh the benefits provided by embodiments of the invention.

In addition to or instead of modifying facial features, embodiments of the invention may also be used to customize other visual aspects of the digital avatar. These may include without limitation: make up, clothing, accessories, body shape variations, age and gender.

Although some aspects have been described in the context of an apparatus, these aspects also represent a description of the corresponding method, where a block or device corresponds to a method step or a feature of a method step. Analogously, aspects described in the context of a method step also represent a description of a corresponding block or item or feature of a corresponding apparatus.

Embodiments of the invention may be implemented in an electronic device, in particular a computer system. The computer system may be a local computer device (e.g., personal computer, laptop, tablet computer or mobile phone) with one or more processors and one or more storage devices or may be a distributed computer system (e.g., a cloud computing system with one or more processors and one or more storage devices distributed at various locations, for example, at a local client and/or one or more remote server farms and/or data centers). The computer system may comprise any circuit or combination of circuits. In one embodiment, the computer system may include one or more processors which can be of any type. As used herein, processor may mean any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, a field programmable gate array (FPGA) or any other type of processor or processing circuit. Other types of circuits that may be included in the computer system may be a custom circuit, an application-specific integrated circuit (ASIC), or the like, such as, for example, one or more circuits (such as a communication circuit) for use in wireless devices like mobile telephones, tablet computers, laptop computers, two-way radios, and similar electronic systems. The computer system may include one or more storage devices, which may include one or more memory elements suitable to the particular application, such as a main memory in the form of random-access memory (RAM), one or more hard drives, and/or one or more drives that handle removable media such as compact disks (CD), flash memory cards, digital video disk (DVD), and the like. The computer system may also include a display device, one or more speakers, and a keyboard and/or controller, which can include a mouse, trackball, touch screen, voice-recognition device, or any other device that permits a system user to input information into and receive information from the computer system.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may, for example, be stored on a machine-readable carrier. Other embodiments comprise the computer program for performing one of the methods described herein, stored on a machine-readable carrier. In other words, an embodiment of the present invention is, therefore, a computer program having a program code for performing one of the methods described herein, when the computer program runs on a computer.

A further embodiment of the present invention is a storage medium (or a data carrier, or a computer-readable medium) comprising, stored thereon, the computer program for performing one of the methods described herein when it is performed by a processor. The data carrier, the digital storage medium or the recorded medium are typically tangible and/or non-transitionary. A further embodiment of the present invention is an apparatus as described herein comprising a processor and the storage medium. A further embodiment of the invention is a data stream or a sequence of signals representing the computer program for performing one of the methods described herein. The data stream or the sequence of signals may, for example, be configured to be transferred via a data communication connection, for example, via the internet. A further embodiment comprises a processing means, for example, a computer or a programmable logic device, configured to, or adapted to, perform one of the methods described herein. A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device, or the like. The apparatus or system may, for example, comprise a file server for transferring the computer program to the receiver.

In some embodiments, a programmable logic device (for example, a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

1. A method of customizing a digital avatar (102), comprising:
displaying a digital avatar (102) on a display (112) of an electronic device; and
providing an audio-visual user interface for customizing the digital avatar (102) based on a spoken conversation between a user (104) and the digital avatar (102).

2. The method of claim 1, further comprising:
receiving, from the user (104) via a microphone (114) of the electronic device, speech input indicating a customization request; and
providing, by the digital avatar (102) via a speaker (116) of the electronic device, speech output indicating a customization response and simultaneously animating the digital avatar (102) on the display (112) of the electronic device consistently with the speech output.

3. The method of claim 2, wherein the customization request comprises a query for customization options; and
wherein the customization response comprises at least one customization option.

4. The method of claim 3, wherein the at least one customization option depends on a state of a current customization session.

5. The method of any one of the preceding claims 2-4, further comprising:
determining whether the customization request meets one or more customization constraints; and
customizing the digital avatar in accordance with the customization request if, preferably only if, the one or more customization constraints are met.

6. The method of any one of the preceding claims, wherein the digital avatar comprises a face with a plurality of customizable facial regions;
wherein each facial region has one or more customizable facial parameters;
wherein the facial regions include one or more of:
nose, with one or more of the following facial parameters: base width, middle width, nostril width, nostril tilt, length, protrusion, dorsal curvature;
mouth, with one or more of the following facial parameters: lip thickness, width, upper lip-to-lower lip ratio, protrusion;
eyes, with one or more of the following facial parameters: width, height, protrusion;
wherein the face has one or more customizable appearance parameters, including one or more of skin tone, eyebrow facial hair, beard facial hair, amount of freckles, eye color, hairstyle;
wherein the plurality of facial regions, facial parameters and/or appearance parameters are independently customizable.

7. The method of any one of the preceding claims, further comprising:
generating an initial configuration of the digital avatar comprising a randomly generated face constructed based on a predefined set of phenotypes;
wherein the predefined set of phenotypes comprises representations of faces digitized from real humans;
wherein the initial configuration is constructed from a random blend of a subset of the predefined set of phenotypes, wherein, preferably, the subset comprises demographically consistent phenotypes.

8. The method of any one of the preceding claims 5-7, wherein the one or more customization constraints are based on a face model which has been trained to learn a variability of facial parameters using a machine-learning technique.

9. A method of generating a face model for use in a method of customizing a digital avatar (102), in particular in accordance with claim 1, comprising:
providing an initial set of phenotypes comprising representations of faces, preferably digitized from real humans;
for each of a selected one of a plurality of facial regions, generating blended facial regions based on a blending of multiple phenotypes, in particular using linear combination.

10. The method of claim 9, further comprising:
generating a low-dimensional representation of the variation in the blended phenotypes, in particular using principal component analysis.

11. The method of any one of claims 9-10, further comprising:
learning a variability of facial parameters in the initial set of phenotypes using a machine-learning technique.

12. A data processing apparatus or system comprising means for carrying out the method of any one of claims 1-11.

13. A computer program or a computer-readable medium having stored thereon the computer program, the computer program comprising instructions which, when executed by a computer, cause the computer to carry out the method of any one of claims 1-11.
